(19) United States
(12) Patent Application Publication
(10) Pub. No.: US 2011/0297046 A1
(43) Pub. Date: Dec. 8, 2011

(54) Kaolin Processing Using Controlled Flow Cavitation

(76) Inventor: Zivorad R. Lazic, Gordon, GA (US)

(21) Appl. No.: 12/792,081

(22) Filed: Jun. 2, 2010

(51) Int. Cl. C04B 14/10

(52) U.S. Cl. 106/488; 106/486

(57) ABSTRACT

This invention is related to processing kaolin by controlled flow cavitation (CFC), and in particular, this invention is directed to kaolin ozonation and/or bleaching processing through application of CFC.

### FIELD OF THE INVENTION

This invention is related to processing kaolin by controlled flow cavitation (CFC), and in particular, this invention is directed to kaolin ozonation and/or bleaching processing through application of CFC.

### BACKGROUND OF THE INVENTION

Wet processing of kaolin is done to better control the particles size distribution, improve brightness through impurity removal and significantly reduce the residue content. Wet processing also enables delamination of kaolin particles that typically have a booklet morphology. Wet processing also involves the use of filtration to build up solids from 15% or higher to 50% or higher to enable cost effective spray drying. The dried kaolin pigment then can be shipped overseas or added back to the filtered product to increase solids for shipping by railroad.

Kaolin beneficiation to improve brightness through flotation and selective flocculation requires that the impurity mineral anatase be liberated and selectively surface treated for separation by either of the processes. The liberation and chemical conditioning steps require high shear agitation. The brightness enhancement through magnetic separation also requires liberation and in case the separation is chemically assisted a conditioning step. The liberation of minerals and conditioning by chemical reagents is typically imparted by mechanical devices that can be modeled as baffled tanks with high shear impellers such as Cowles dissolver. It is believed that devices capable of imparting significantly increased amount of shear would improve the efficacy of the liberation and the conditioning steps. The CFC process results in extreme turbulence and is thus expected to lead to significant improvements in degree of liberation and conditioning of the kaolin slurry.

Delamination of kaolin booklets to result in thin platelets or higher aspect ratio particles not only helps particle recovery but provide significant functional advantage such as better coverage of substrates such as paper. Delamination is achieved though devices that are in effect stirred media mills using sand, glass or polymeric particles as the media. Again, the extreme turbulence generated in the CFC process is expected to lead to strong particle-particle collisions that would delaminate the particles without using any media and may result in smoother particles (desirable feature).

It would be an advancement in the art to proceed with kaolin ozonation and bleaching processing through application of CFC process that results in either productivity improvement or process performance/capability improvements, or both.

### SUMMARY OF THE INVENTION

The invention consists of improvements in kaolin processing technology through application of controlled flow cavitation (CFC) process that results in either productivity improvements or process capability improvements or both. These benefits can also apply to mineral processing in general where wet processing and significant energy input is required.

### DETAILED DESCRIPTION OF THE INVENTION

One aspect of this invention is directed to ozonated bleaching of kaolin. In this embodiment, crude kaolin is typically pretreated with sand removal, bleaching with sodium chlorite and dispersed with sodium silicate slurry. Magnetic separation is then used to remove metallic impurities, and flotation processes are used to remove organic impurities. Other pretreating processes including bleaching, thickening and flotation processes are used prior to putting in slurry form.

In accordance to this invention, the slurry is then

The slurry form is then treated through a CFC. In an embodiment of this invention, the controlled cavitation process is used to mix a two-phase fluid of gases and liquids in a mechanical device. The energy output or the degree of mixing of the gases and liquids is determined by a number of factors such as the size of the rotor, number of cavities, degree of angle of the cavities, tolerances between the housing and endplates, revolutions per minute of the rotor and the mechanical energy input.

The filtered product, which is used to make spray dried products or for slurry shipment after addition of spray dried material to increase solids, is obtained via dispersion of filter cake which is at 50% or higher solids. Again, the dispersion is achieved by high shear agitation of the filter cake in presence of chemical dispersants. The CFC process is expected to breakdown agglomerates especially that involve ultrafine particles (less than 0.3 micron) more effectively and thus improve the rheological behavior of the kaolin product.

In one embodiment, the CFC process is conducted by a mechanical device called a Shockwave Power™ Generator, from Hydro Dynamics of Rome, Ga. Initial test work with an ultrawhite product (RUW) showed equivalent to improved product brightness could be realized with standard ozone dosage (0.5 ppt) and 5.0 ppt of bleach (sodium hydrosulfite) (Table 1 & Table 2). This could be accomplished without air dilution or use of a contactor column.

TABLE 1
BASF HDl Testing 6 Aug

| RUW | | Flow Rate | GAS Flow | Concentration | % Ozone | Rsults | | |
|---|---|---|---|---|---|---|---|---|
| Sample | RPM (Hz) | Clay (GPM) | SCH | Ozone | pounds/ton | GEB | Ti02 | Fe |
| 10 | Feed | | | | | 88.1 | 0.59 | 0.96 |
| 11 | 1800 (30) | 15 | 95 | 5 | 0.5 | 89.5 | 0.59 | 0.94 |
| 12 | 3600 (60) | 15.7 | 95 | 5 | 0.5 | 89.6 | 0.6 | 0.95 |
| 13 | 3600 (60) | 13 | 140 | 8 | 1.5 | 89.9 | 0.61 | 0.97 |
| 14 | 3600 (60) | 14.8 | 50 | 10.6 | 0.5 | 89.8 | 0.61 | 0.95 |
| 15 | 3600 (60) | 9.8 | 95 | 10.7 | 1.5 | 90.0 | 0.59 | 0.96 |
| 16 | 3600 (60) | 4.9 | 95 | 5.9 | 1.5 | 90.3 | 0.58 | 0.96 |

TABLE 2
BASF HDl Testing 19 Aug

| | | | | | | Rsults | | |
|---|---|---|---|---|---|---|---|---|
| RUW | | | | | | GEB | Ti02 | Fe |
| 30 | Feed | | | | | 88.0 | 0.60 | 0.97 |
| 31 | 3600 (60) | 16.5 | 60 | 8 | 0.5 | 90.2 | 0.58 | 0.96 |
| 32 | 3600 (60) | 14.8 | 120 | 8 | 1 | 90.6 | 0.57 | 0.97 |
| 33 | 3600 (60) | 8.5 | 120 | 8 | 1.5 | 91.0 | 0.60 | 0.95 |
| 34 | 3600 (60) | 6.5 | 80 | 8 | 2 | 91.0 | 0.59 | 0.96 |

A second testing tier was then conducted at the an optimal ozone addition rate/concentration, See Table 3. In these tests, RUW product brightness potential was shown to increase well above the control benchmark by increasing ozone dosage.

TABLE 3
BASF HDI Testing 14 October

| | | Flow Rate | Concen- | % Ozone | |
|---|---|---|---|---|---|
| Sample | RPM | Clay | tration | pounds/ | |
| RUW | (Hz) | (GPM) | Ozone | ton | GEB |
| RUW Feed | | | | | 88.7 |
| Plant Control | | | | | 90.5 |
| RUW Lab Control | | | | | 90.4 |
| 1 (RUW) | 3600 (60) | 15 | 8 | 0.5 | 90.7 |
| 2 (RUW) | 3600 (60) | 15 | 8 | 1 | 90.9 |
| 3 (RUW) | 3600 (60) | 10 | 8 | 1.5 | 91.2 |
| 4 (RUW) | 3600 (60) | 5 | 8 | 2 | 91.3 |
| 5 (RUW) 5 min | 3600 (60) | 15 | 8 | 0.5 | 90.5 |
| 5 (RUW) 15 min | 3600 (60) | 15 | 8 | 0.5 | 90.7 |
| 5 (RUW) 30 min | 3600 (60) | 15 | 8 | 0.5 | 91.0 |
| 5 (RUW) 60 min | 3600 (60) | 15 | 8 | 0.5 | 91.0 |
| 6 (RUW) | 3600 (60) | 15 | 10 | 0.5 | 90.6 |

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A process for processing kaolin or other mineral slurries which comprises treating crude pretreated kaolin through a controlled flow cavitation process to mix a two-phase fluid of gases and liquids.

2. The process of claim 1 wherein utilizes a CFC device to efficiently mix a two-phase system consisting gas(es) and a liquid.

3. The process of claim 1 wherein the controlled flow cavitation process is preceded by a mechanical device or chemical process.

4. The process of claim 3 wherein kaolin or other mineral slurry is oxidatively bleached with ozone using a CFC process.

5. The process of claim 4 that is preceded by the addition of suitable oxidizing and for reducing chemical agents that will promote brightness beneficiation.

6. The process of claim 4 that is followed by the addition of suitable oxidizing and/or reducing chemical agents that will promote brightness beneficiation.
